(19) United States
(12) Patent Application Publication
(10) Pub. No.: US 2014/0242954 A1
(43) Pub. Date: Aug. 28, 2014

(54) LOCATION-RELEVANT DATA

(71) Applicant: MICROSOFT CORPORATION, Redmond, WA (US)

(72) Inventors: John Chang, Stockholm (SE); Shadi Mahassel, London (GB)

(73) Assignee: MICROSOFT CORPORATION, Redmond, WA (US)

(21) Appl. No.: 13/776,623

(22) Filed: Feb. 25, 2013

(51) Int. Cl. H04W 4/02

(52) U.S. Cl. CPC H04W 4/02
USPC 455/414.1

(57) ABSTRACT

Method, server and computer program product for providing data to a user device, wherein the user device is connectable to a network. The server of the network determines locations of interest for a user of the user device based on analysis of one or more factors including analysis of one or more of: (i) details of contacts of the user, and (ii) event details in an electronic calendar of the user. The server determines location-relevant data for the determined locations of interest. Whilst the user device is connected to the network, the server automatically sends the determined location-relevant data over the network to the user device for storage therein, such that the location-relevant data is subsequently available at the user device when the user device is not connected to the network.

### RELATED APPLICATION

This application claims priority under 35 USC 119 or 365 to Great Britain Application No. 1300023.7 filed Jan. 2, 2013, and this application is also related to U.S. patent application Ser. No. 13/426,158, filed Mar. 21, 2012, the disclosure of which is incorporated in its entirety.

### BACKGROUND

Networks, such as the Internet, can store vast quantities of data. Users can access data stored in a network using a user device to connect to the network and retrieve the data therefrom. However, for some user devices (e.g. mobile devices) it may be the case that the user device can sometimes, but not always, connect to the network. For example, a mobile user device, such as a smart phone, tablet or laptop, may be able to connect to the network via a wireless access point (e.g. a “Wi-Fi hotspot”) when the mobile user device is within range of the wireless access point. Wireless access points often have ranges of the order of tens or hundreds of metres. For example, a user may have a wireless Wi-Fi router in their home via which a user device can connect to the network when the user device is within range of the wireless router. Public venues, such as shops or airports, may provide Wi-Fi hotspots to user devices which are within range of the Wi-Fi hotspots. Public Wi-Fi hotspots are wireless networks that offer internet access in publicly accessible areas. Such wireless networks may be open (non-password protected), although some may require a password or other form of authentication for access. A mobile device may move such that sometimes it can connect to the network via a wireless access node and sometimes it cannot. Similarly, a mobile device may connect to a network, such as the Internet, via a cellular telephone network. A cellular telephone network typically comprises a plurality of base stations which are spread geographically to provide cellular coverage to different locations. The mobile device may move such that sometimes it can connect to the network via a base station of the cellular network and sometimes it cannot.

There may be other reasons why a user device cannot connect to a network. For example, a Wi-Fi hotspot may be broken, the user may not have a compatible account or compatible networking hardware for accessing the network according to a particular technology (e.g. GSM or CDMA), the user may not have sufficient funds on their account for accessing the network, or the service may be too costly for the user 102 (e.g. the costs for day passes or roaming fees for accessing the network may be too high).

If a user device is in a state (e.g. location) in which it cannot connect to the network, then it cannot retrieve data from the network. It may therefore be useful for a user to download data from the network at a time when the user device is connected to the network and store the downloaded data at the user device, such that the data can be used at the user device at a time when the user device cannot connect to the network. However, there may be too much data on a network such as the Internet to download all of the available data from the network for storage at the user device.

One situation in which a user device may not be able to connect to the network is when the user is travelling, taking the user device with him as he travels. A travel application may organise information in terms of downloadable data packages corresponding to regions (or “locations”), such as countries, cities or neighbourhoods. Each data package may include location-relevant data for a particular location, such as details of Wi-Fi hotspots, details of venues at the location, and other data which may be relevant to the respective location. The user can choose to download a data package (sometimes at a cost) before a trip, to his user device at a time when the user device can connect to the Internet (such as via a wireless access point at the user's home or work). The data packages can be stored at the user device so that the travel application can use the data packages at the user device without an internet connection while the user is traveling. This means that the user must plan his travel and configure the travel application correspondingly in advance, which can be tedious for the user and not always possible.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

There is provided a method of providing data to a user device, wherein the user device is connectable to a network (e.g. the Internet). In the method, a server of the network determines locations of interest for a user of the user device based on analysis of one or more factors including analysis of one or more of: (i) details of contacts of the user, and (ii) event details in an electronic calendar of the user. The server determines location-relevant data for the determined locations of interest. Whilst the user device is connected to the network, the server automatically sends the determined location-relevant data over the network to the user device for storage therein. The location-relevant data is subsequently available at the user device when the user device is not connected to the network.

The steps of the method can be executed by an application executed by a processor on the server without user intervention (i.e. automatically). For example, the server automatically sends the determined location-relevant data to the user device. In this way, the location-relevant data is pre-fetched, without user intervention. The details of contacts of the user and/or the event details in the user's electronic calendar are analysed to determine locations of interest for the user. For example, the server may determine locations of contacts of the user within an online social network, wherein the locations of the contacts may be used to indicate locations of interest for the user. As another example, any locations indicated in the event details (e.g. past details, present details or future details) of the user's electronic calendar may be locations that the user may have an interest in, e.g. future details may indicate locations that the user may travel to or locations about which the user may be interested to retrieve information. In this way, the server can filter the available data in the network to determine the location-relevant data which relates to locations that may be of interest to the user. Since the server has determined that the user has some interest in the locations of interest, the location-relevant data for those locations may be of interest to the user, and as such those pieces of location-relevant data are sent to the user device for storage therein.

For example, the location-relevant data may comprise details of a wireless access node (e.g. the Media Access Control (MAC) address or the Service Set Identifier (SSID) of the wireless access node) which is within range at the location of interest. By downloading the details of the wireless access node to the user device when the user device is connected to the network, then subsequently when the user device is at the particular location of interest it can retrieve the details of the wireless access node from its memory (rather than needing to use the Wi-Fi radio on the user device to scan for available Wi-Fi networks) and connect to the wireless access node using the retrieved details.

### BRIEF DESCRIPTION OF THE DRAWINGS

FIG. 1 shows a first schematic illustration of a network;

FIG. 2 shows a second schematic illustration of the network;

FIG. 3 is a flow chart for a process of providing data to a user device; and

FIG. 4 is a flow chart for a process of hotspot detection.

### DETAILED DESCRIPTION

Location-relevant data such as travel information may be pre-fetched for offline use at a user device, by determining locations of interest for a user of the user device based on, for example, data from the user's electronic calendar, social networks and/or other web services. For example, data from social networks may be used to determine places of interest for a user that may be potentially relevant to a user's future travels. In this way, location-relevant data can be determined and downloaded to the user's user device with minimal user interaction.

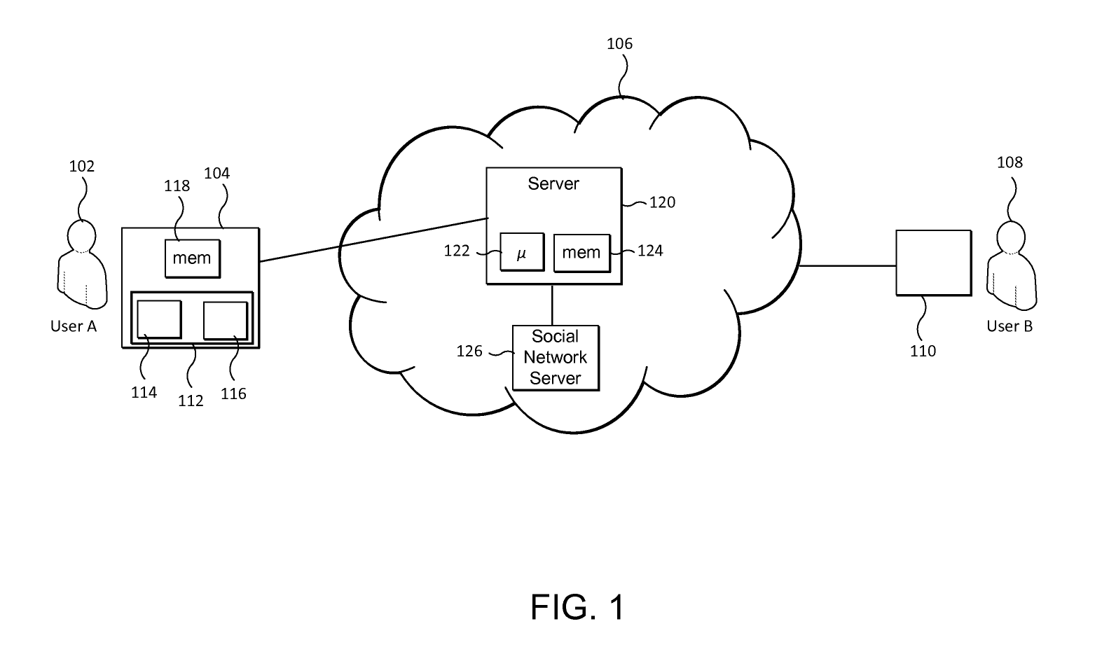

FIG. 1 is a schematic diagram of a network 106 to which user devices can connect. In particular, the user 102 (User A) can use user device 104 to connect to the network 106, and the user 108 (User B) can use user device 110 to connect to the network 106. In the examples described herein, the network 106 is the Internet, but in other examples the network 106 may be any other network (e.g. a LAN of a workplace) which can store data which may be of interest to the user 102. The user device 104 comprises a processor 112, on which applications can be executed. For example, as shown in FIG. 1, user device 104 may execute an application 114 on the processor 112 for communicating over the network 106 with a server 120 of the network 106. The server 120 manages the pre-fetching of location-relevant data for the user device 104 as described in more detail below. The user device 104 may also execute an electronic calendar application 116 on the processor 112 into which details of an itinerary of the user 102 can be added. The user device 104 also comprises a memory 118 configured for storing data. The user device 110 may include similar elements to those described herein in relation to user device 104, but they are not described herein for conciseness.

The server 120 comprises a processor 122 which is configured to execute computer program code. The server 120 also comprises a memory 124 configured for storing data. The network 106 also comprises a social network server 126 which is a server for an online social network, such as Skype™, Facebook, Twitter, Foursquare, LinkedIn, etc. The user 102 has an account with the online social network, and may use the online social network to communicate with other users (or “contacts”) within the online social network. For example, the users 102 and 108 may be contacts of each other within the online social network. The user devices 104 and 110 may for example execute software clients provided by a service provider of the online social network in order to access the online social network, e.g. to communicate over the online social network.

As described above, the user device 104 may be a mobile device (such as a mobile phone, tablet, laptop or other portable electronic device capable of connecting to the internet 106), and it may be the case that the user device 104 can sometimes, but not always, connect to the network 106. For example, the user device 104 may move in and out of range of wireless access nodes which allow the user device 104 to connect wirelessly to the network 106 using W-Fi technology. As another example, the user device 104 may move in and out of the coverage area of base stations of a mobile cellular network which allow the user device 104 to connect wirelessly to the network 106 via the cellular network. There may be other reasons why the user device 104 temporarily cannot connect to the network 106. For example, a Wi-Fi hotspot may be broken, the user 102 may not have a compatible account or compatible networking hardware for accessing the network 106 according to a particular technology (e.g. GSM or CDMA), the user 102 may not have sufficient funds on their account for accessing the network 106, or the service may be too costly for the user 102 (e.g. the costs for day passes or roaming fees for accessing the network may be too high).

When the user device 104 is connected to the network 106 then it may be able to retrieve data from the network 106. However, when the user device 104 is in a state in which it cannot connect to the network 106, then it cannot retrieve data from the network 106. It may therefore be useful to download data from the network 106 when the user device 104 is connected to the network 106 and store the data in the memory 118 of the user device 104, such that the data can be used at the user device 104 at a subsequent time when the user device 104 cannot connect to the network 106. However, the network 106 (e.g. the Internet) may store a vast amount of data, and there may be too much data stored on the network 106 to download all of the data from the network 106 for storage in the memory 118 of the user device 104.

It may therefore be useful to filter the available data stored on the network 106 in order to provide only relevant data to the user device 104. For example, it is useful to provide data to the user device 104 that will subsequently be used at the user device 104. However, it is not so useful to provide data to the user device 104 that is not subsequently used at the user device 104. One way to determine which data may be relevant for use at the user device 104 is to determine which data is relevant to locations that are of interest to the user 102.

Locations of interest for the user may for example be locations to which the user 102 is intending to travel, or may be locations about which the user 102 is interested for other reasons, for example if the user 102 has many friends in a particular location then he may be interested in data that is relevant to that location.

Location-relevant data is any data that may be relevant to a particular location, such as one or more of: details (e.g. SSID and MAC address) of wireless access nodes at the location, venue names, venue addresses, venue phone numbers, other venue contact information, menus, maps, photos, logos, quality ratings, reviews, geolocation details and advertising content relevant for the respective locations of interest.

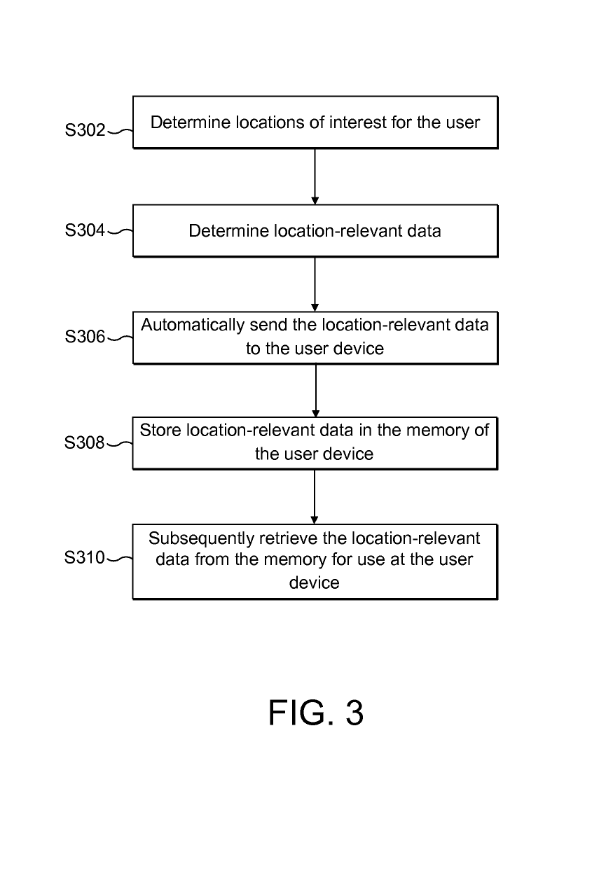

FIG. 3 shows a flow chart for a process of providing data to the user device 104 according to some embodiments. In step S302 the server 120 determines locations of interest for the user 102. The server 120 does this based on analysis of one or more factors which may indicate that a location is of interest to the user. In this way, the server 120 can compile the most relevant data customized for the user 102 based on some heuristics, which may involve weightings which are adjustable at the server 120.

As a first example, the server 120 may determine the locations of interest for the user 102 based on an analysis of details of contacts of the user 102. The user's “contacts”, may also be referred to as the user's “friends” or “buddies”. The contact details may be stored at the user device 104, e.g. in a contact list or an address book stored in the memory 118 of the user device 104. The contact details can be retrieved from the memory 118. Alternatively, the contact details may be stored in a store which is located at another node of the network 106 (i.e. in a “cloud-based” store). For example, the contact details may be stored in the user's account on the social network, and may be retrievable from the store by accessing the user's account in the social network using the social network server 126.

For example, the server 120 may determine the locations of interest for the user 102 based on an analysis of the user's online social network account. Location metadata for contacts of the user 102 (e.g. user 108 may be contact of user 102) which may be stored at the user device 104 (or a summary thereof) can be sent from the user device 104 over the network 106 to the server 120 for use in this analysis. Alternatively, the user's social network credentials (e.g. login details) may be sent from the user device 104 to the server 120. The server 120 can then communicate with the social network server 126 over the network 106, and using the user's social network credentials can directly access details (e.g. location status or calendar) of the user's contacts within the social network.

In some cases, it is possible to obtain explicit data about the user's travel plans, such as from travel-oriented web services on the network 106, or alternatively from event-based web services such as Google Calendar. This data can be used to pre-fetch information relevant to the user's travels, so that the information will be available when it's needed and the user is offline (i.e. without a connection to the network 106). Unfortunately, this kind of data isn't always available, as users may not always use these web services. However, many people do use the social networks mentioned above such as Skype, Facebook, Twitter, Foursquare, and LinkedIn. Social networks allow a user to manage lists of contacts (family, friends, acquaintances, schoolmates, colleagues, etc.) and access self-published information from those contacts. Critically, one kind of information that is commonly available is a contact's location. (Note that the granularity of each contact's location may vary widely (from specific street address to neighbourhood, city, region, state, or country), since the information is self-published and not standardised, but this becomes of little consequence when this information is processed in aggregate). It is assumed that the user 102 is most likely to travel to parts of the world where he or she has existing contacts within the social network. By collecting the locations of a user's social network contacts, the parts of the world that are of potential relevance to a user's future travels can be determined. For example, if a user has many contacts in San Francisco, it can be assumed that a user is more likely to travel to San Francisco than a location in which he has few or no contacts. Therefore, it would be advantageous to automatically download travel information or other data relevant for San Francisco, without having to ask the user 102 to input his or her travel plans or preferences manually.

Therefore, the server 120 may determine locations of respective contacts of the user 102 (e.g. contacts within the online social network or contacts whose details are stored at the user device 104 e.g. in an address book or contact list), wherein the determined locations of contacts of the user 102 are used as the determined locations of interest for the user. This is on the basis that the user 102 may subsequently be interested in data that is relevant to the locations of his contacts, e.g. the user 102 may travel to locations at which he has contacts.

As a second example, the server 120 may determine the locations of interest for the user 102 based on an analysis of event details in the electronic calendar 116. The electronic calendar may be stored at the user device 104. Location metadata for the electronic calendar 116 (or a summary thereof) can be sent from the user device 104 over the network 106 to the server 120 for use in this analysis. The electronic calendar may be stored at a node of the network 106 other than the user device 104. The event details in the electronic calendar may relate to past, present or future events. The server 120 may analyse the event details in the electronic calendar 116, to determine past, present or future locations of the user 102 indicated in the electronic calendar 116, wherein the determined locations of the user are used as the determined locations of interest for the user. This is on the basis that the user 102 may subsequently be interested in data that is relevant to his future location (for example, when the event details indicate to a location of a future event). The user 102 may also subsequently be interested in data that is relevant to his past or present location (for example, when the event details indicate a location of a past or present event) because these are locations in which the user 102 has some association with. In other words, as well as using the future details from the user's electronic calendar 116, the server 120 may also use past details from the user's electronic calendar 116 which can also be useful in determining which locations may be of interest to the user 102.

As a third example, the server 120 may determine the locations of interest for the user 102 based on the user's current and/or past location. The user device 102 may comprise geolocation apparatus for detecting the location of the user device 102. The geolocation apparatus can take any suitable form, for example GPS (Global Positioning System), A-GPS (Assisted GPS) and similar technologies can be used. In addition the geolocation device can be implemented in the form of software which uses information such as mobile network tower signals, wireless internet signals and IP addresses to self-locate the user device 104 in a manner known per se. The geolocation apparatus is capable of providing geolocation data which locates the user device 104 with respect to a set of positioning coordinates, such as longitude and latitude coordinates, without using a Wi-Fi radio on the user device 104 to locate a Wi-Fi hotspot. The server 120 may use the current location of the user device 104, or past locations of the user device 104 to determine the locations of the interest for the user 102. This is on the basis that the user 102 may subsequently be interested in data that is relevant to his current location or to locations that he has previously been to.

As a fourth example, the server 120 may determine the locations of interest for the user 102 based on the user's contact card which may indicate locations at which the user is likely to spend significant amounts of time, for example the user's home and work addresses. This information may be received at the server 120 from the user device 104. Based on this information the server 120 may determine that the user may be interested in data that is relevant in the proximity of, or between, the indicated locations.

Therefore, in the examples given above, the server 120 determines the locations of interest for the user 102, without the user 102 being required to indicate which locations are of interest to him. Instead the server 120 uses information relating to the user's contacts (e.g. from an account in the social network), the user's electronic calendar, the user's location and/or the user's contact card to determine the locations of interest for the user 102. The server 120 does this automatically. That is, the server 120 performs step S302 without intervention from the user 102.

One or more of the factors described in the examples above may be used by the server 120 to determine the locations of interest for the user 102 in step S302. The server 120 may also analyse other factors to those described in the examples given above to determine the locations of interest for the user 102.

In step S304 the server determines location-relevant data for the locations of interest determined in step S302. This may involve the server 120 retrieving the location-relevant data from wherever it is stored in the network 106 (e.g. from the user device 104 or from the “cloud”, that is, from another node in the network 106). As described above, the location-relevant data is any data that may be relevant to the respective location of interest, such as one or more of: details (e.g. SSID and MAC address) of wireless access nodes at the location, venue names, venue addresses, venue phone numbers, other venue contact information, menus, map tiles, photos, logos, quality ratings, reviews, geolocation details and advertising content relevant for the respective locations of interest. The server 120 determines the location-relevant data, without intervention from the user 102. That is, the server 120 automatically determines the location-relevant data, e.g. by accessing data stored in the network 106, either at the server 120 itself or elsewhere within the network 106.

The amount of location-relevant data determined for each of the determined locations of interest may be weighted according to the analysis used in step S302. For example, different ones of the factors that are analysed in step S302 may influence the weightings for the determined locations of interest to different extents. For example, when the server 120 analyses the user's social network account, the respective weighting for each of the determined locations of interest may be determined based on one or more of: (i) the number of the user's contacts at the respective location of interest, and (ii) which of the user's contacts are at the respective location of interest. Furthermore, the respective weighting for each of the determined locations of interest may be determined based on the type of the location-relevant data.

In step S306 the server 120 automatically sends the location-relevant data to the user device 104 over the network 106 whilst the user device 104 is connected to the network 106. In step S308 the location-relevant data is stored in the memory 118 of the user device 104. The location-relevant data is stored in cache memory within the memory 118. The cache memory 118 has a fixed capacity (i.e. a fixed maximum size) for storing the location-relevant data, to ensure that the amount of location-relevant data stored at the user device 104 does not grow out of control. The contents of the cache are expired based on some heuristic, e.g. a first-in-first-out (FIFO) ordering. The location-relevant data may be stored at the user device 104 in the form of a database holding a plurality of data entries for the locations of interest and the respective pieces of the location-relevant data for those locations of interest.

In step S310 the location-relevant data is subsequently retrieved from the memory 118 for use at the user device 104. For example, this step may be performed when the user device 104 is not connected to the network 106. This allows the user 102 to access the location-relevant data at the user device 104 even when the user device 104 is not connected to the network 106.

When the user device 104 is connected to the network 106, the location-relevant data can be retrieved for use at the user device 104 from the memory 118. This may be quicker and use less processing resources and/or network resources than retrieving the location-relevant data from the network 106. Therefore, even when the user device 104 is connected to the network 106 there may still be some benefit to have already pre-fetched the location-relevant data and stored it in the memory 118.

It is apparent that no user intervention is required for any of steps S302, S304, S306 or S308. Therefore, without the user 102 being required to do anything, whilst the user device 104 is connected to the network 106, location-relevant data for locations of interest for the user is sent from the server 120 to the user device 104 and stored therein. This means that the user 102 may not need to plan for occasions when the user device 104 may not be able to connect to the network 106. This can be particularly useful when the user 102 is travelling with the user device 104 and therefore frequently moving between locations at which the user device 104 is connected to the network 106 and locations at which the user device 104 is not connected to the network 106. The user 102 may find it difficult to plan in advance himself for such situations in which the user device 104 is not connected to the network 106.

There are therefore provided methods to pre-fetch location-relevant data such as travel information for offline use at the user device 104, by determining locations of interest for the user 102, e.g. based on data from social networks and other web services. The location-relevant data may be identified based on the predicted future location of the user 102. This can be predicted from third party applications, the user's calendar information, the user's past and current location and/or the user's contact location in the social network. The location-relevant data is downloaded to the user device 104 when the user 102 is online (that is, when the user device 104 is connected to the network 106) and can be made available at the user device 104 when the user 102 is offline (that is, when the user device 104 is not connected to the network 106). As described in more detail below, a particular piece of the location-relevant data may optionally be presented at the user device 104 to the user 102 in response to detecting that the user device 104 is located in a particular location corresponding to the particular piece of location-relevant data, using the geolocation apparatus available on the user device 104.

The method shown in FIG. 3 may be initiated by the application 114 executed on the processor 112 of the user device 104. That is, whilst the user device 104 is connected to the network 106, the application 114 requests more up-to-date and/or more relevant data from the server 120, thereby initiating the method shown in FIG. 3 and described above. The application 114 may request the location-relevant data from the server 120 automatically, that is without user intervention from the user 102. The application 114 may request the location-relevant data from the server 120 periodically. In one example, the frequency with which the application requests the location-relevant data from the server 120 (and thereby the frequency with which the server automatically sends the determined location-relevant data over the network 106 to the user device 104 whilst the user device 104 is connected to the network 106) is predetermined, and may be for example, once a month, once a week or once a day. In an alternative example, the frequency with which the application requests the location-relevant data from the server 120 (and thereby the frequency with which the server automatically sends the determined location-relevant data over the network 106 to the user device 104 whilst the user device is connected to the network 106) is determined based on one or more of: (a) the type of connection with which the user device 104 is connected to the network 106 (for example, if the user device 104 is connected to the network 106 via a Wi-Fi connection then the frequency may be higher than if the user device 104 is connected to the network 106 via a cellular mobile network), and (b) the type of the location-relevant data (for example, if the location-relevant data relates to details (which may be subject to frequent changes) for connecting to a wireless access node at the location then the frequency may be higher than if the location-relevant data relates to the contact details of a restaurant at the location, which will typically not change as frequently).

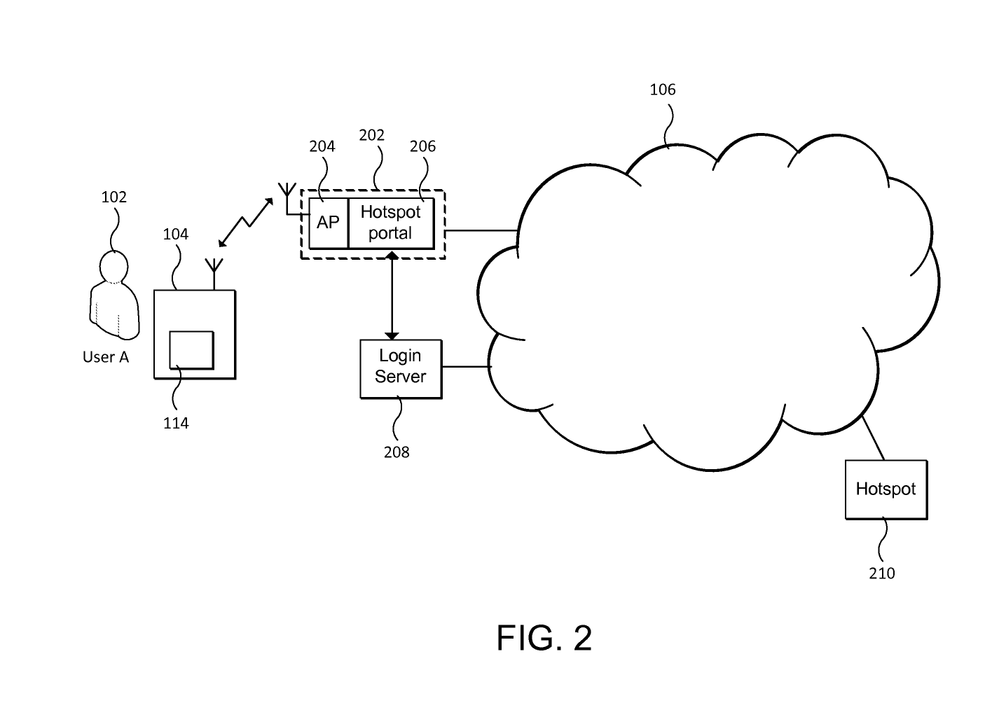

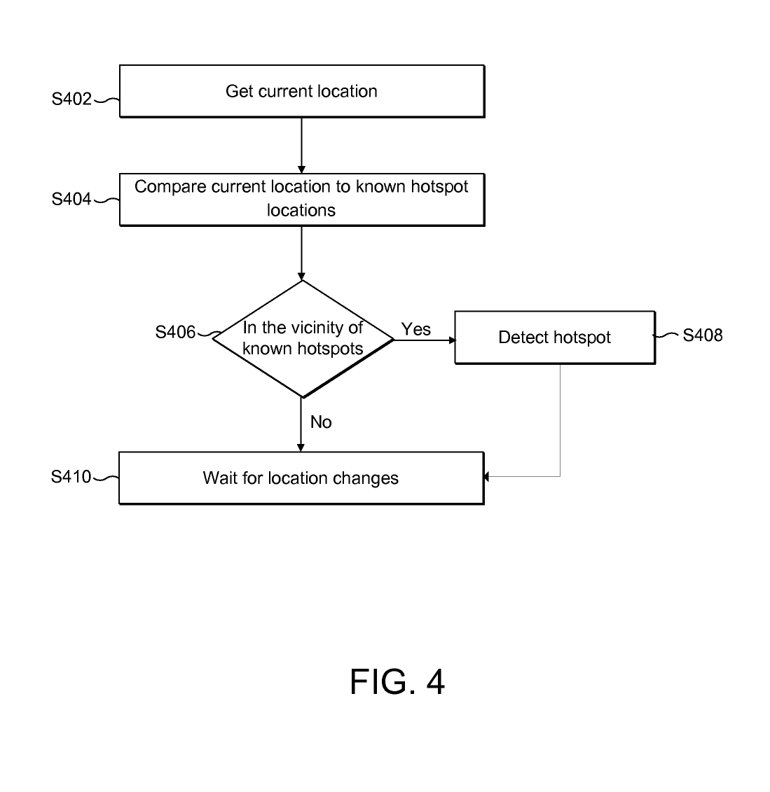

In an embodiment, which is described in more detail below and with reference to FIGS. 2 and 4, the location-relevant data comprises details (e.g. MAC address and SSID) of Wi-Fi hotspots at the corresponding location. This may be particularly useful when the user 102 is travelling and would want to be able to find Wi-Fi hotspots to get online. The Wi-Fi hotspot information may include not only the network name and cost, but also other displayable information about the hosting venue, such as the venue name, type, address, directions, map, contact info, ratings, photos, menu, reviews, etc. which may be displayed to the user 102 at the user device 104.

As described above, in step S302 the server 120 may analyse the current location of the user 102. In an example, it is found that the user 102 is in Soho, London. In this case, the server 120 may return details of a hundred Wi-Fi hotspots (e.g. most popular, best rated, etc.) in the vicinity of the geolocation of the user 102. Also as described above, in step S302 the server 120 may analyse a contact card of the user 102. In an example, it is found that the user 102 works in Soho and lives in the East End of London. In this case, the server 120 may return details of a hundred Wi-Fi hotspots located between those two locations, with the assumption that the user 102 may want to stop somewhere between his home and work.

Also as described above, in step S302 the server 120 may analyse the user's social network account as well as the current location of the user 102. In an example, the user 102 is determined to be currently in London and based on the server's analysis of the user's social network, it is found that the user 102 has five contacts in San Francisco and one contact in Stockholm. The server 120 may return details of fifty Wi-Fi hotspots in London, forty Wi-Fi hotspots in San Francisco, and ten Wi-Fi hotspots in Stockholm. In this example, it can be seen that 50% of the locations of interest are determined based on the user's current location, and 50% are determined based on the metadata from the user's contacts in the social network. In this sense the weights applied to the different factors (user's current location and user's contact details in the social network) are 50:50. Furthermore, since more of the user's contacts are located in San Francisco than in Stockholm, details of more Wi-Fi hotspots in San Francisco than in Stockholm are returned.

Also as described above, in step S302 the server 120 may analyse the future details of the user's electronic calendar. In an example, it is found that the user 102 is traveling from London to Stockholm tomorrow. In this case, the server 120 may return details of ten Wi-Fi hotspots in London, forty Wi-Fi hotspots in Stockholm, and fifty Wi-Fi hotspots in airports and hotels between London and Stockholm. In this sense much of the server output is weighted based on the knowledge that the user 102 is travelling the next day, predicting that the user 102 will likely need data relating to the destination as well as airports and hotels along the way between the origin and destination of his planned travel.

The Wi-Fi hotspot information is provided automatically to the user device 104 and stored in the memory 118 as described above with reference to FIGS. 1 and 3. In the example shown in FIG. 2, the user device 104 comprises a network interface that is able to connect to a WLAN access node 202. The access node 202 comprises an access point (“AP”) 204, which provides wireless connections to the access node 202, and a hotspot portal 206, which controls whether a user device is able to connect to the access node 202. The AP 204 and hotspot portal 206 can be co-located in a single entity, or be provided in distinct separate entities. However, regardless of the structural layout, the functionality of the two elements is the same, such that the hotspot portal 206 controls whether a user device is able to connect to the packet-based network 106 (e.g. the Internet) via the AP 204. The hotspot portal 206 provides functionality such as redirection for authentication and payment. Also connected to the network 106 is a login server 208 which provides web-pages for login or related to login, to which the user is redirected by the hotspot portal 206 upon beginning the login process.

When the user 102 is travelling it is likely that he is not in the vicinity of known Wi-Fi networks (hotspots), such as at home or work. Furthermore, there may be in any particular location more than one possible hotspot available to the user 102 (illustrated for example as hotspot 210 in FIG. 2). Due to the scarcity and time cost of battery charging opportunities while the user 102 is travelling, it is also likely that maximising battery life span is even more important than usual. At the same time, it is desirable to provide an indication to the user 102 whenever there is a public Wi-Fi hotspot nearby in case he or she wants to go online, i.e. connect to the network 106.

In accordance with embodiments of the present invention, this is achieved by using geolocation data to sense when the user 102 has moved in and out of the vicinity of known supported hotspots. To this end, as described above, the user device 104 includes geolocation apparatus and stores, in the memory 118, a database of known supported hotspots at different locations (as provided by the server 120 according to the methods described above with reference to FIGS. 1 and 3). As described above, the geolocation apparatus is capable of providing geolocation data which locates the user device 104 with respect to a set of positioning coordinates, such as longitude and latitude coordinates, without using the radio on the user device 104 to locate the hotspot. The coordinates obtained by the geolocation apparatus are compared with data in the database. The database holds for each entry a hotspot identification and corresponding geolocation data, such as positioning coordinates. Thus, a comparison can be made to see whether the user 102 is in the vicinity of a hotspot which is in the database. In this way, detection of Wi-Fi hotspots is optimised by avoiding the need to continuously scan for available Wi-Fi networks (“polling”), or even to keep the Wi-Fi radio powered at all. This is advantageous, because Wi-Fi has a much higher power consumption than GPS (which is one of the possibilities for the geolocation apparatus). GPS is a much simpler, receive only mechanism. It may be advantageous to minimise the use of Wi-Fi whenever it is not strictly necessary, and embodiments of the present invention enable this by making use of the geolocation data determined by the geolocation apparatus, in conjunction with the database of known hotspots.

As mentioned above the database of known supported hotspots can be stored in the memory 118. Initially the database may be empty or prepopulated with a number of known supported hotspots, and may be updated dynamically according to methods described above with reference to FIGS. 1 and 3.

The database can be populated in a number of different ways. For example, where the hotspot detection method is implemented as a computer program which can be downloaded, such as an app (application), when the user 102 downloads the application they could download in addition a “canned” database. Alternatively, it may be possible to start the application with no database or an empty one, and then have the server 120 provide more data, before the hotspot detection feature of the application is usable. In practice, a combination of these techniques can be utilised to support millions of hotspots worldwide requiring a massive amount of data. Since the data changes on a daily basis, it may be desirable to export a small “canned” database of most popular hotspots, then allow the download (by the server 120) of fresher data and/or more data for specific regions of interest (for example, in anticipation of a trip).

Reference will now be made to FIG. 4 to describe a method of detecting hotspots in accordance with one embodiment of the present invention. At step S402, the current location of the user device 104 is obtained by action with the geolocation apparatus as described above. The geolocation data is supplied from the geolocation apparatus for comparison at the user device 104 in step S404 with known hotspot locations in the database.

If a comparison results in information that the user device 104 is in the vicinity of a known hotspot (S406), the hotspot is detected by powering on the network interface of the user device 104 (if it was powered off), or by causing a poll of the network interface if it was already powered on. Once detected, an indication is given to the user on the display of the user device 104 that he can now connect to the network 106 via the detected hotspot.

If the comparison at step S404 results in an indication that the user device 104 is not in the vicinity of a known hotspot, at step S410 the method waits for the location of the user device 104 to change, and then commences again at step S402. It is also noted that while a particular hotspot has been detected, should the user device 104 change its position, this is similarly detected at step S410 and the method reverts to step S402. In this way, the user device 104 is automatically kept in touch with available hotspots in its vicinity.

Thus, embodiments of the present invention allow for the optimised detection of public Wi-Fi hotspots in the manner of an automatic search process that does not require user interaction, such as checking a map, browsing a list or entering a query string.

Generally, any of the functions described herein (e.g. the functional steps shown in FIGS. 3 and 4) can be implemented in modules using software, firmware, hardware (e.g., fixed logic circuitry), or a combination of these implementations. The steps shown separately in FIGS. 3 and 4 may or may not be implemented as separate modules or steps. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described herein are platform-independent, meaning that the techniques may be implemented on a variety of commercial computing platforms having a variety of processors.

For example, the user devices may also include an entity (e.g. software) that causes hardware of the user devices to perform operations, e.g., processors functional blocks, and so on. For example, the user devices may include a computer-readable medium that may be configured to maintain instructions that cause the user devices, and more particularly the operating system and associated hardware of the user devices to perform operations. Thus, the instructions function to configure the operating system and associated hardware to perform the operations and in this way result in transformation of the operating system and associated hardware to perform functions. The instructions may be provided by the computer-readable medium to the user devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of providing data to a user device, said user device being connectable to a network, the method comprising the following steps being performed at a server of the network:
determining locations of interest for a user of the user device based on analysis of one or more factors including analysis of one or more of: (i) details of contacts of the user, and (ii) event details in an electronic calendar of the user;
determining location-relevant data for the determined locations of interest;
whilst the user device is connected to the network, automatically sending the determined location-relevant data over the network to the user device for storage therein, such that the location-relevant data is subsequently available at the user device when the user device is not connected to the network.

2. The method of claim 1 wherein said analysis includes retrieving details from a store and analysing the retrieved details, wherein the store is located at either: (i) the user device, or (ii) another node of the network.

3. The method of claim 1 further comprising the server retrieving the details of the contacts from a contact list or an address book stored at the user device.

4. The method of claim 1 further comprising the server retrieving the details of the contacts from an account of the user within an online social network.

5. The method of claim 4 further comprising the server receiving the user's social network credentials and using the received social network credentials to access the user's social network account for said retrieving of the details of the contacts, and wherein the server performs said analysis of the details of the contacts.

6. The method of claim 5 wherein the step of determining locations of interest for the user comprises the server determining locations of respective contacts of the user within the social network, wherein said determined locations of contacts of the user are used as said determined locations of interest for the user.

7. The method of claim 1 wherein the event details in the electronic calendar relate to past, present or future events.

8. The method of claim 1 wherein the electronic calendar is stored at the user device and wherein the method further comprises receiving, at the server, the event details in the electronic calendar from the user device, and wherein the server performs said analysis of the received event details in the electronic calendar of the user.

9. The method of claim 8 wherein the step of determining locations of interest for the user comprises the server determining past, present or future locations of the user indicated in the event details in the electronic calendar, wherein said determined locations of the user are used as said determined locations of interest for the user.

10. The method of claim 1 wherein said determination of the locations of interest for the user is performed based on analysis of more than one factor.

11. The method of claim 1 wherein said analysis of factors further includes analysis of one or both of the user's current location and the user's past location.

12. The method of claim 1 wherein the amount of location-relevant data determined for each of the determined locations of interest is weighted according to said analysis.

13. The method of claim 12 when dependent upon claim 10 wherein different ones of said analysed factors influence the weightings for the determined locations of interest to different extents.

14. The method of claim 12 when dependent upon claim 6 wherein the respective weighting for each of the determined locations of interest is determined based on one or more of: (i) the number of the user's contacts at the respective location of interest, and (ii) which of the user's contacts are at the respective location of interest.

15. The method of claim 12 wherein the respective weighting for each of the determined locations of interest is determined based on the type of the location-relevant data.

16. The method of claim 1 wherein the location-relevant data comprises details of wireless access nodes which are accessible at the respective locations of interest.

17. The method of claim 1 wherein the location-relevant data comprises details that are relevant for the respective locations of interest, including one or more of: venue names, venue addresses, venue phone numbers, other venue contact information, menus, maps, photos, logos, quality ratings, reviews, geolocation details and advertising content relevant for the respective locations of interest.

18. The method of claim 1 wherein the frequency with which the server automatically sends the determined location-relevant data over the network to the user device whilst the user device is connected to the network is either predetermined or determined based on one or more of: (a) the type of connection with which the user device is connected to the network, and (b) the type of the location-relevant data.

19. A server of a network configured to provide data to a user device, said user device being connectable to the network, the server comprising a processor and being configured to execute a computer program product on the processor to perform the steps of:
determining locations of interest for a user of the user device based on analysis of one or more factors including analysis of one or more of: (i) details of contacts of the user, and (ii) event details in an electronic calendar of the user;
determining location-relevant data for the determined locations of interest;
whilst the user device is connected to the network, automatically sending the determined location-relevant data over the network to the user device for storage therein, such that the location-relevant data is subsequently available at the user device when the user device is not connected to the network.

20. A computer program product configured to provide data to a user device, said user device being connectable to a network, the computer program product being embodied on a computer-readable storage medium and configured so as when executed on a processor of a server of a network to perform the operations of any of:
determining locations of interest for a user of the user device based on analysis of one or more factors including analysis of one or more of: (i) details of contacts of the user, and (ii) event details in an electronic calendar of the user;
determining location-relevant data for the determined locations of interest;
whilst the user device is connected to the network, automatically sending the determined location-relevant data over the network to the user device for storage therein, such that the location-relevant data is subsequently available at the user device when the user device is not connected to the network.
